(19) United States
(12) Patent Application Publication
(10) Pub. No.: US 2023/0205952 A1
(43) Pub. Date: Jun. 29, 2023

(54) MODELING METHOD FOR SOFT MEASUREMENT OF TEMPERATURE OF BLAST FURNACE TUYERE RACEWAY

(71) Applicant: Northeastern University, Shenyang City, Liaoning Province (CN)

(72) Inventors: Minghan WU, Shenyang City, Liaoning Province (CN); Yingwei ZHANG, Shenyang City, Liaoning Province (CN); Lin FENG, Shenyang City, Liaoning Province (CN)

(21) Appl. No.: 17/769,002

(22) PCT Filed: Dec. 3, 2021
(86) PCT No.: PCT/CN2021/135432

§ 371 Date: Apr. 14, 2022

(30) Foreign Application Priority Data
May 21, 2021 (CN) 202110557533.X

(51) Int. Cl. G06F 30/27; G06V 10/56

(52) U.S. Cl. CPC G06F 30/27; G06V 10/56

(57) ABSTRACT

A modeling method for soft measurement of temperature of a blast furnace tuyere raceway includes: collecting picture data of flame combustion at the blast furnace tuyere raceway, physical variable data reflecting operation states of a blast furnace and combustion temperature data of the blast furnace tuyere raceway; extracting characteristics of the picture data of the flame combustion; constructing a multi-kernel least squares support vector regression model based on Pearson correlation coefficient method and least squares support vector regression algorithm as a soft measurement model; optimizing parameters of the soft measurement model by using sine cosine optimization algorithm; and taking optimal kernel function parameters of the picture data, kernel function parameters of the physical variable data and regularization parameters in the multi-kernel least squares support vector regression model as final parameters of the soft measurement model, and achieving prediction and calculation of the combustion temperature of the blast furnace tuyere raceway.

### BACKGROUND OF THE INVENTION

### 1. Field of the Invention

The present invention relates to the technical field of blast furnace ironmaking, in particular to a modeling method for soft measurement of temperature of a blast furnace tuyere raceway.

### 2. The Prior Arts

A blast furnace is a very important component in a smelting process, and serves as a core link in the whole system. Raw materials in the blast furnace are iron ore, limestone, coke and other substances, which are fed into the blast furnace from the upper part of the blast furnace, and reach a tuyere raceway after passing through a lumpy zone, a cohesive zone and a dropping zone. The tuyere raceway is formed in front of a tuyere, and is not only the area where reduced gas and enormous heat energy are generated, but also the area where the oxidation-reduction reaction of the substances occurs most violently. In the tuyere, hot air and pulverized coal are continuously blown in to provide energy for pig iron smelting so as to ensure normal operation of the blast furnace. The operation state of the tuyere raceway serving as the core area in the blast furnace is crucial.

The temperature is a key parameter reflecting a smelting process state. The temperature of the tuyere raceway plays a role in guiding workers to judge the operation condition of the tuyere raceway. However, the internal temperature of the blast furnace is hard to measure by the workers due to technological characteristics and structural factors of the blast furnace, so that the exact value of the internal temperature of the tuyere raceway cannot be obtained on site; and operators cannot adjust parameters of blast, coal injection, and the like of the blast furnace in time, and the production efficiency is reduced. Therefore, it is of great significance to know the exact temperature value of the blast furnace tuyere raceway on site.

### SUMMARY OF THE INVENTION

In order to solve the technical problems and overcome the defects in the prior art, the present invention provides a modeling method for soft measurement of temperature of a blast furnace tuyere raceway. The temperature of the blast furnace tuyere raceway is calculated, and the problem that judgement on the internal combustion temperature of the blast furnace tuyere raceway is inaccurate is solved.

In order to solve the technical problem, the modeling method for soft measurement of temperature of the blast furnace tuyere raceway comprises the following steps:

Step 1: collecting picture data of flame combustion at the blast furnace tuyere raceway, physical variable data reflecting operation states of a blast furnace and combustion temperature data of the blast furnace tuyere raceway.

Step 1.1: collecting the picture data of flame combustion at the blast furnace tuyere raceway.

Step 1.2: collecting the physical variable data reflecting the operation states of the blast furnace, wherein the physical variable data reflecting the operation states of the blast furnace includes hot air temperature, hot air pressure, cold air flow, furnace top pressure, pure oxygen flow and gas utilization rate.

Step 1.3: collecting the combustion temperature data of the blast furnace tuyere raceway.

Step 2: extracting characteristics of the picture data of the flame combustion at the blast furnace tuyere raceway.

Step 2.1: converting the picture data of flame combustion at the blast furnace tuyere raceway, collected in step 1.1, into an HSV color space from an RGB color space.

Step 2.2: extracting HSV nonuniform quantization characteristics of the picture data of flame combustion at the blast furnace tuyere raceway from an HSV color space.

Step 3: constructing a multi-kernel least squares support vector regression model based on a Pearson correlation coefficient method and a least squares support vector regression algorithm as a soft measurement model for the temperature of the blast furnace tuyere raceway.

Step 3.1: using the picture data of flame combustion at the blast furnace tuyere raceway, and the physical variable data reflecting the operation states of the blast furnace, obtained in step 1.1 and step 1.2, as sample input data, and using the combustion temperature data of the blast furnace tuyere raceway, obtained in step 1.3, as sample temperature label data.

Step 3.2: determining kernel function types and the kernel function parameters corresponding to the picture data collected in step 1.1 and the physical variable data collected in step 1.2, and calculating kernel matrices corresponding to the picture data and the physical variable data respectively.

Step 3.3: multiplying the combustion temperature data and a transpose vector thereof to construct a tuyere raceway combustion temperature data matrix on the premise of limiting the combustion temperature data of the blast furnace tuyere raceway obtained in step 1.3 as a column vector.

Step 3.4: expanding by columns the kernel matrices calculated according to the picture data and the physical variable data in step 3.2 and the tuyere raceway combustion temperature data matrix constructed in step 3.3, and converting the kernel matrices into corresponding column vectors.

Step 3.5: calculating a correlation coefficient between the column vectors corresponding to the picture data and the column vectors corresponding to the tuyere raceway combustion temperature data matrix by using the Pearson correlation coefficient method; and calculating the correlation coefficient between the column vectors corresponding to the physical variable data and the column vectors corresponding to the tuyere raceway combustion temperature data matrix by using the Pearson correlation coefficient method.

Step 3.6: determining weights of the kernel matrices of the picture data and the physical variable data, and constructing a combined kernel matrix of the blast furnace tuyere raceway by using a weighted summation method.

After the correlation coefficients between the column vectors corresponding to the picture data and the column vectors corresponding to the tuyere raceway combustion temperature data matrix and between the column vectors corresponding to the physical variable data and the column vectors corresponding to the tuyere raceway combustion temperature data matrix are calculated in step 3.5 by using the Pearson correlation coefficient method, respectively, taking a respective proportion of the correlation coefficients corresponding to the picture data and the physical variable data to a sum of the correlation coefficients as a weight of each kernel matrix; and multiplying the kernel matrices of the picture data and the physical variable data by respective weights, and then performing a summation to form the combined kernel matrix.

Step 3.7: constructing the multi-kernel least squares support vector regression model based on the least squares support vector regression algorithm by using the combined kernel matrix constructed in step 3.6 and the temperature label data in step 3.1 as the soft measurement model for the temperature of the blast furnace tuyere raceway.

Step 4: optimizing the parameters of the soft measurement model for the temperature of the blast furnace tuyere raceway by using the sine cosine optimization algorithm.

Step 4.1: determining parameter optimization objects, wherein the parameter optimization objects are the kernel function parameters of the picture data and the kernel function parameters of the physical variable data in step 3.2, and the regularization parameters in the multi-kernel least squares support vector regression model.

Step 4.2: taking a root mean square error index of the soft measurement model for the temperature of the blast furnace tuyere raceway in step 3 as the fitness function of the sine cosine optimization algorithm, calculating all the processes in step 3 in a cyclic iteration before optimal parameters are obtained, and ending the parameter optimization process after iterative termination conditions set by the sine cosine optimization algorithm are met.

Step 5: taking optimal kernel function parameters of the picture data, kernel function parameters of the physical variable data and the regularization parameters in the multi-kernel least squares support vector regression model, found in step 4, as the final parameters of the soft measurement model for the temperature of the blast furnace tuyere raceway, and achieving prediction and calculation of the combustion temperature of the blast furnace tuyere raceway.

The beneficial effects achieved by adopting the technical solution lie in that, in the modeling method for soft measurement of the temperature of the blast furnace tuyere raceway, a temperature measuring instrument is not required for directly measuring temperature, and the temperature value can be predicted and calculated by means of relevant physical variable data and picture data; and the temperature value of the blast furnace tuyere raceway can be calculated more accurately. Meanwhile, according to the method provided by the present invention, the picture data of the blast furnace tuyere raceway is introduced into a temperature soft measurement model, and joint modeling of the picture data and the physical variable data of the blast furnace tuyere raceway is achieved after nonuniform quantization characteristics of the picture data are extracted. In order to solve the problem that base kernel matrix weights are hard to distribute during construction of a combined kernel matrix, a Pearson correlation coefficient is introduced for determining the weights, so that data fusion effects from different perspectives are better, and the model learning ability is stronger. In order to solve the problem that model parameters are hard to adjust, the sine cosine optimization algorithm is introduced for determining the parameters, not only is the parameter adjustment difficulty reduced, but also the prediction accuracy of the model is improved.

### BRIEF DESCRIPTION OF DRAWINGS

FIG. 1 is a flow chart of a modeling method for soft measurement of temperature of a blast furnace tuyere raceway according to the embodiment of the present invention;

FIG. 2 is a detail flow chart of the modeling method for soft measurement of temperature of the blast furnace tuyere raceway according to the embodiment of the present invention;

FIG. 3 is an iterative curve diagram of a sine cosine optimization algorithm according to the embodiment of the present invention;

FIG. 4 is a follow effect diagram of a soft measurement model for the temperature of the blast furnace tuyere raceway according to the embodiment of the present invention on first 50 samples of training data; and

FIG. 5 is a follow effect diagram of a soft measurement model for the temperature of the blast furnace tuyere raceway according to the embodiment of the present invention on first 50 samples of test data.

### DETAILED DESCRIPTION OF THE PREFERRED EMBODIMENT

The specific implementations of the invention are described in more detail below with reference to the accompanying drawings and embodiments. The following embodiments are intended to illustrate the invention, rather than to limit the scope of the invention.

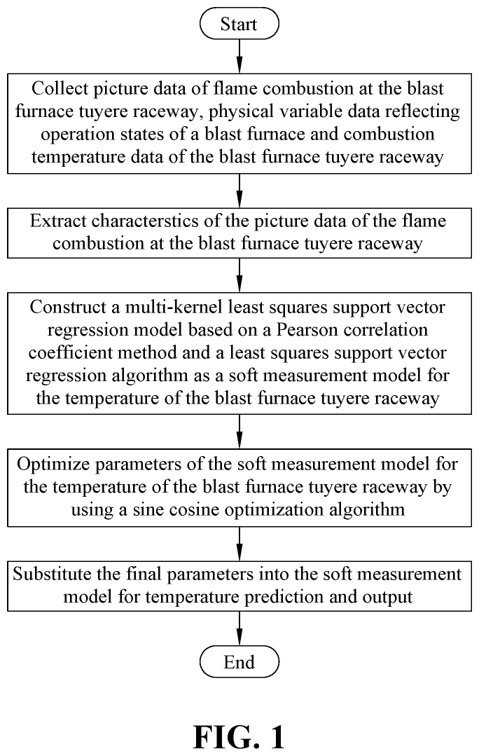

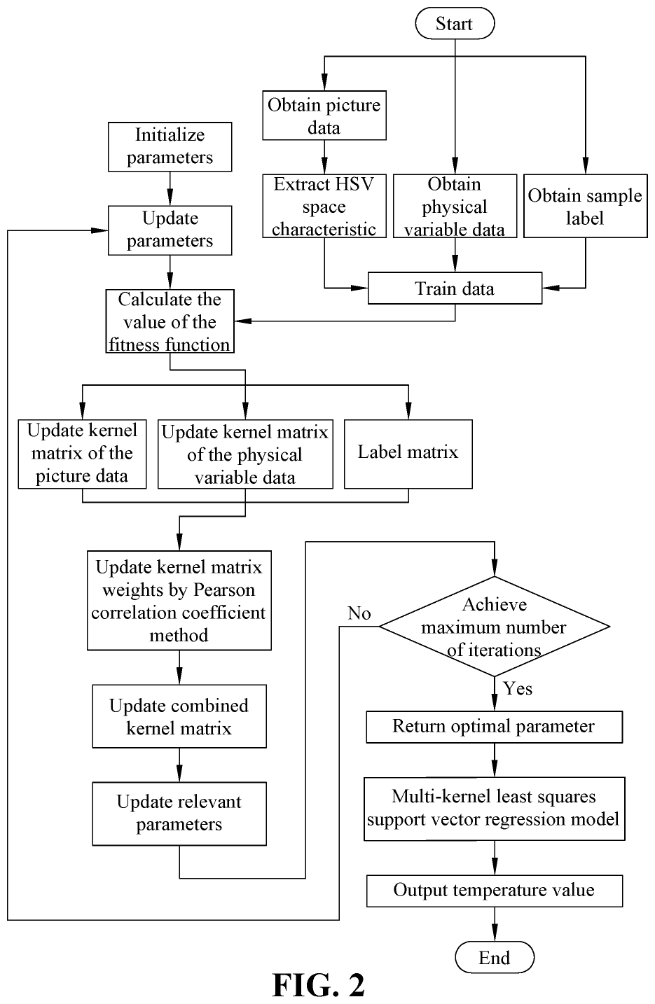

In the embodiment, a modeling method for soft measurement of temperature of a blast furnace tuyere raceway, as shown in FIG. 1 and FIG. 2, comprises the following steps:

Step 1: collecting picture data of flame combustion at the blast furnace tuyere raceway, physical variable data reflecting operation states of a blast furnace and combustion temperature data of the blast furnace tuyere raceway as sample data.

Step 1.1: collecting the picture data of flame combustion at the blast furnace tuyere raceway.

Step 1.2: collecting the physical variable data reflecting the operation states of the blast furnace, wherein the physical variable data reflecting the operation states of the blast furnace includes hot air temperature, hot air pressure, cold air flow, furnace top pressure, pure oxygen flow and gas utilization rate.

Step 1.3: collecting the combustion temperature data of the blast furnace tuyere raceway.

In this example, 1200 pieces of sample data are collected, and each sample data comprises the picture data of flame combustion at the blast furnace tuyere raceway, the physical variable data reflecting the operation states of the blast furnace, and the combustion temperature data of the blast furnace tuyere raceway; the sample data is divided into a training dataset consisting of 1000 samples, and a test dataset consisting of 200 samples, wherein the training dataset can be divided into a training set consisting of 900 samples and a validation set consisting of 100 samples in more detail.

Step 2: extracting characteristics of the picture data of the flame combustion at the blast furnace tuyere raceway.

Step 2.1: converting the picture data of flame combustion at the blast furnace tuyere raceway, collected in step 1.1, into an HSV color space from an RGB color space.

Step 2.2: extracting HSV nonuniform quantization characteristics of the picture data of flame combustion at the blast furnace tuyere raceway from an HSV color space.

HSV is a color space focusing on hue, saturation and brightness, a nonuniform quantization method of the HSV is a technology of extracting characteristics, which can better reflect change of the color space to provide convenience for research on the characteristics of the picture data, color grades are reclassified by the nonuniform quantization method of the HSV according to the hue, saturation and brightness, after a one-dimensional synthesis formula is used, two-dimensional picture data is converted into one-dimensional histogram characteristic vectors, so that people can be more familiar with the picture data characteristics, many nonuniform quantization methods are provided, common nonuniform quantization methods include 72-dimensional nonuniform quantization and 166-dimensional nonuniform quantization. However, in order to properly extract the information of the color space in pictures, 256-dimensional nonuniform quantization is adopted in the embodiment. The following quantization rules are adopted for the 256-dimensional nonuniform quantization.

For the hue H:

if H∈(345,15], the hue H grade is quantized to 0,

if H∈(15,25], the hue H grade is quantized to 1,

if H∈(25,45], the hue H grade is quantized to 2,

if H∈(45,55], the hue H grade is quantized to 3,

if H∈(55,80], the hue H grade is quantized to 4,

if H∈(80,108], the hue H grade is quantized to 5,

if H∈(108,140], the hue H grade is quantized to 6,

if H∈(140,165], the hue H grade is quantized to 7,

if H∈(165,190], the hue H grade is quantized to 8,

if H∈(190,220], the hue H grade is quantized to 9,

if H∈(220,255], the hue H grade is quantized to 10,

if H∈(255,275], the hue H grade is quantized to 11,

if H∈(275,290], the hue H grade is quantized to 12,

if H∈(290,316], the hue H grade is quantized to 13,

if H∈(316,330], the hue H grade is quantized to 14, and

if H∈(330,345], the hue H grade is quantized to 15.

For the saturation S:

if S∈[0, 0.15], the saturation G grade is quantized to 0,

if S∈(0.15,0.4], the saturation G grade is quantized to 1,

if S∈(0.4,0.75], the saturation G grade is quantized to 2, and

if S∈(0.75,1], the saturation G grade is quantized to 3.

For the brightness V:

if V∈[0,0.15], the brightness V grade is quantized to 0,

if V∈(0.15,0.4], the brightness V grade is quantized to 1,

if V∈(0.4,0.75], the brightness V grade is quantized to 2, and

if V∈(0.75, 1], the brightness V grade is quantized to 3.

After three color components are combined according to the following formula, one-dimensional histogram characteristics can be obtained, and the formula is represented as:

L=16H+4S+V

wherein L represents a value that the pictures are subjected to HSV nonuniform quantization.

Although this example is to extract 256-dimensional HSV nonuniform quantization characteristics from the picture data, 207-dimensional characteristics are only included due to the characteristics of the collected picture data, and therefore, only these 207-dimensional data is adopted for modeling after elimination of invalid information.

Step 3: constructing a multi-kernel least squares support vector regression model based on a Pearson correlation coefficient method and a least squares support vector regression algorithm as a soft measurement model for the temperature of the blast furnace tuyere raceway.

Step 3.1: using the picture data of flame combustion at the blast furnace tuyere raceway, and the physical variable data reflecting the operation states of the blast furnace, obtained in step 1.1 and step 1.2 as sample input data, and using the combustion temperature data of the blast furnace tuyere raceway, obtained in step 1.3, as sample temperature label data.

Step 3.2: determining kernel function types and kernel function parameters corresponding to the picture data collected in step 1.1 and the physical variable data collected in step 1.2, and calculating kernel matrices corresponding to the picture data and the physical variable data respectively.

In the embodiment, the kernel functions of the picture data and the physical variable data are selected as Gaussian kernel functions, and then the corresponding kernel matrices are constructed.

Step 3.3: multiplying the combustion temperature data and a transpose vector thereof to construct a tuyere raceway combustion temperature data matrix on the premise of limiting the combustion temperature data of the blast furnace tuyere raceway obtained in step 1.3 as a column vector.

A label vector is a column vector, and a matrix is constructed after the label vector is multiplied by the transpose vector thereof, so that conversion of the label vector to the label matrix is achieved.

Step 3.4: expanding by columns the kernel matrices calculated according to the picture data and the physical variable data in step 3.2 and the tuyere raceway combustion temperature data matrix constructed in step 3.3, and converting the kernel matrices into corresponding column vectors.

Step 3.5: calculating a correlation coefficient between the column vectors corresponding to the picture data and the column vectors corresponding to the tuyere raceway combustion temperature data matrix by using the Pearson correlation coefficient method; calculating the correlation coefficient between the column vectors corresponding to the physical variable data and the column vectors corresponding to the tuyere raceway combustion temperature data matrix by using the Pearson correlation coefficient method.

The Pearson correlation coefficient is a statistic for calculating the degree of correlation between any two variables X and Y, and generally reflects the linear relation between the two variables. If the positive linear correlation between the two variables is high, the Pearson correlation coefficient is closer to 1; if the negative linear correlation between the two variables is high, the Pearson correlation coefficient is closer to −1; and if no linear correlation between the two variables exists, the Pearson correlation coefficient is closer to 0. The specific calculation of the Pearson correlation coefficient can be completed through Matlab built-in functions.

Since the Pearson correlation coefficient is a statistic for calculating the correlation between vectors, the matrices should be processed when the correlation between the kernel matrices and the label matrices are calculated. After the kernel matrices and temperature label matrices of the picture data and the physical variable data are expanded by columns to form a column vector, the Pearson correlation coefficient between the column vectors is calculated, and the Pearson correlation coefficient between the corresponding column vectors serves as Pearson correlation coefficient between the matrices.

Step 3.6: determining weights of the kernel matrices of the picture data and the physical variable data, and constructing a combined kernel matrix of the blast furnace tuyere raceway by using a weighted summation method.

After the correlation coefficients between the column vectors corresponding to the picture data and the column vectors corresponding to the tuyere raceway combustion temperature data matrix and between the column vectors corresponding to the physical variable data and the column vectors corresponding to the tuyere raceway combustion temperature data matrix are calculated in step 3.5 by using the Pearson correlation coefficient method separately, taking the proportion of the correlation coefficients corresponding to the picture data and the physical variable data to the sum of the population correlation coefficients as the weight of each kernel matrix; and multiplying the kernel matrices of the picture data and the physical variable data by respective weights, and then performing adding to form the combined kernel matrix.

Step 3.7: constructing the multi-kernel least squares support vector regression model based on the least squares support vector regression algorithm by using the combined kernel matrix constructed in step 3.6 and the temperature label data in step 3.1 as the soft measurement model for the temperature of the blast furnace tuyere raceway.

The construction process of the multi-kernel least squares support vector regression model is mainly divided into two parts, namely multi-kernel learning and least squares support vector regression.

1. Multi-Kernel Learning:

Multi-kernel learning is a method for learning modeling by using multiple kernel functions. Compared with a single-kernel model, a multi-kernel learning model has the effects that the characteristics in data can be learned properly, and therefore, the classification accuracy or prediction accuracy of the model for the sample data is improved.

The multi-kernel learning kernel matrix is constructed by adopting a weighted summation method, and specifically shown as the following formula:

$$k ( x , z ) = {\sum }_{j = 1}^{M} {β}_{j} \hat{{k}_{j}} ( x , z ) , {β}_{j} \geq 0 , {\sum }_{j = 1}^{M} {β}_{j} = 1 ,$$

wherein M represents the total number of the kernel matrices, \hat{k}ⱼ(x,z) represents the base kernel matrix, k(x,z) represents the combined kernel matrix, βⱼ represents weight of the base kernel matrix, and x and z represent the sample data.

2. Least Squares Support Vector Regression:

The least squares support vector regression objective function is shown:

$${min}_{ω , b} \frac{1}{2} {‖ ω ‖}^{2} + \frac{1}{2} γ {\sum }_{i = 1}^{N} {e}_{i}^{2} ,$$

$$s . t . {y}_{i} = {ω}^{T} φ ( {x}_{i} ) + b + {e}_{i} , i = 1 , … , N$$

wherein γ is a regularization parameter, eᵢ represents an error, N is the number of samples, yᵢ represents the sample true output, ω and b represent model parameters to be determined, φ represents a mapping function of the least squares support vector regression algorithm, xᵢ represents sample data.

The calculation formula of a Lagrange multiplier method corresponding to the objective function is shown:

$$L ( ω , b , e , α ) = \frac{1}{2} {‖ ω ‖}^{2} + \frac{1}{2} γ {\sum }_{i = 1}^{N} {e}_{i}^{2} + {\sum }_{i = 1}^{N} {α}_{i} ( {y}_{i} - {ω}^{T} φ ( {x}_{i} ) - b - {e}_{i} ) ,$$

wherein L(ω, b, e, α) represents a Lagrange function, and αᵢ represents a Lagrange multiplier.

After partial derivatives are taken with respect to the parameters in the formula, it is shown:

$$\{ \begin{matrix}\frac{\partial L}{\partial ω} = ω - {\sum }_{i = 1}^{N} {α}_{i} φ ( {x}_{i} ) = 0 \\ \frac{\partial L}{\partial b} = - {\sum }_{i = 1}^{N} {α}_{i} = \\ \frac{\partial L}{\partial {e}_{i}} = γ {e}_{i} - {α}_{i} = 0 \\ \frac{\partial L}{\partial {α}_{i}} = {y}_{i} - {ω}^{T} φ ( {x}_{i} ) - b - {e}_{i} = 0.\end{matrix}$$

After ω and eᵢ are eliminated, the following linear equation system is obtained:

$$[ \begin{matrix}0 & {\vec{1}}^{T} \\ \vec{1} & Ω + {γ}^{- 1} I\end{matrix} ] [ \begin{matrix}b \\ α\end{matrix} ] = [ \begin{matrix}0 \\ y\end{matrix} ] ,$$

wherein [y=y₁, y₂, . . . , y_{N}]^{T}, [α=α₁, α₂, . . . , α_{N}]^{T} and \vec{1} are top-all column vectors, and \vec{1}∈R^{N} and I are unit matrices, Ω is the kernel matrix meeting the following form:

Ωᵢⱼ=φ(xᵢ)φ(xⱼ), ∀i,j∈{1, . . . ,N}.

It is assumed that V=Ω+γ⁻¹I, it can be seen from the formula that V is reversible, the solution of the linear equation system is shown:

$$\{ \begin{matrix}{b}^{*} = \frac{{\vec{1}}^{T} {v}^{- 1} y}{{\vec{1}}^{T} {v}^{- 1} \vec{1}} \\ {α}^{*} = {V}^{- 1} ( y - b \vec{1} )\end{matrix} ,$$

wherein α* and b* represent the model parameters of the least squares support vector regression algorithm.

The fitting function of the least squares support vector regression finally determined is shown:

$$f ( x ) = {\sum }_{i = 1}^{N} {α}_{i}^{*} K ( {x}_{i} , x ) + {b}^{*} ,$$

wherein K(xᵢ,x) represents the kernel matrix, and xᵢ and x represent samples.

Part 1 and part 2 are combined to obtain the fitting function of the multi-kernel least squares support vector regression model, specifically shown as the following formula:

$$f ( x ) = {{\sum }_{i = 1}}^{N} {α}_{i}^{*} ( {β}_{1} {K}_{1} ( {x}_{io 1} , {x}_{n 1} ) + {β}_{2} {K}_{2} ( {x}_{io 2} , {x}_{n 2} ) ) + {b}^{*} .$$

The method in the present invention only contains data from two perspectives, pictures are data from the first perspective, and physical variable data are data from the second perspective. β₁ represents the weight of the kernel matrix of the picture data, β₂ represents the weight of the kernel matrix of the physical variable data, and β₁ and β₂ can be calculated in steps 3.2-3.5; xᵢₒ₁ represents the training sample of the picture data, xₙ₁ represents the test sample of the picture data, xᵢₒ₂ represents the training sample of the physical variable data, xₙ₂ represents the test sample of the physical variable data, K₁(xᵢₒ₁, xₙ₁) represents the kernel matrix of the picture data, K₂(xᵢₒ₂, xₙ₂) represents the kernel matrix of the physical variable data, f(x) represents the model output, and definitions of other parameters in the formula are as stated in the above technical solution.

Step 4: optimizing the parameters of the soft measurement model for the temperature of the blast furnace tuyere raceway by using the sine cosine optimization algorithm.

Step 4.1: determining parameter optimization objects, wherein the parameter optimization objects are the kernel function parameters of the picture data and the kernel function parameters of the physical variable data in step 3.2, and the regularization parameters in the multi-kernel least squares support vector regression model.

In the iterative optimization process, after the picture data kernel function parameters and the physical variable kernel function parameters are determined, the weights of the picture data kernel matrix and the physical variable data kernel matrix can be calculated through steps 3.2-3.5, so that the weights of the kernel matrices of the picture data and the physical variable data are not regarded as the parameter optimization objects.

Step 4.2: taking a root mean square error index of the soft measurement model for the temperature of the blast furnace tuyere raceway in step 3 as the fitness function of the sine cosine optimization algorithm, calculating all the processes in step 3 in a cyclic iteration before the optimal parameters are obtained, and ending the parameter optimization process after iterative termination conditions set by the sine cosine optimization algorithm are met.

The parameter updating calculation formula of the sine cosine optimization algorithm is shown as follows:

$${X}_{i}^{t + 1} = \{ \begin{matrix}{X}_{i}^{t} + {r}_{1} \times sin ( {r}_{2} ) \times \vert {r}_{3} {P}_{i}^{t} - {X}_{i}^{t} \vert , {r}_{4} < 0.5 \\ {X}_{i}^{t} + {r}_{1} \times cos ( {r}_{2} ) \times \vert {r}_{3} {P}_{i}^{t} - {X}_{i}^{t} \vert , {r}_{4} < 0.5\end{matrix} ,$$

wherein, Xᵢ^{t} is the position of the current solution in the i-th dimension during the t-th iteration, r₁, r₂ and r₃ are all random components, Pᵢ^{t} is the position of the target parameter in the i-th dimension during the t-th iteration, ∥ represents an absolute value, r₄ is a random number from 0 to 1.

r₁ is changed and updated according to the following formula:

$${r}_{1} = a - t \frac{a}{T} ,$$

wherein a is a constant, t is the number of current iterations, and T is the total number of iterations.

Step 5: taking optimal kernel function parameters of the picture data, kernel function parameters of the physical variable data and the regularization parameters in the multi-kernel least squares support vector regression model found in step 4 as the final parameters of the soft measurement model for the temperature of the blast furnace tuyere raceway, and achieving prediction and calculation of the combustion temperature of the blast furnace tuyere raceway.

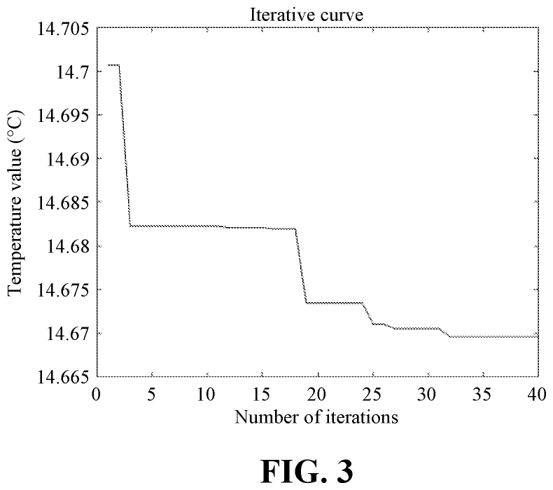

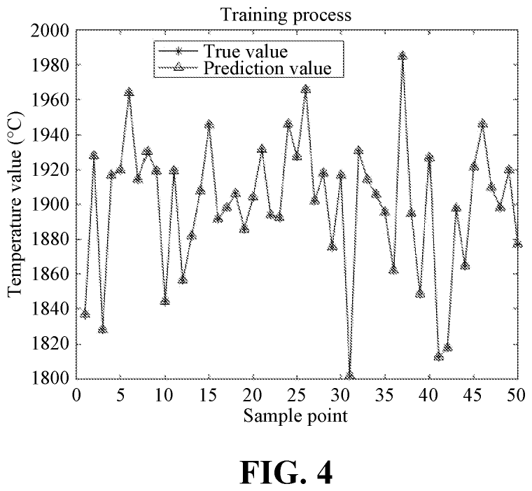

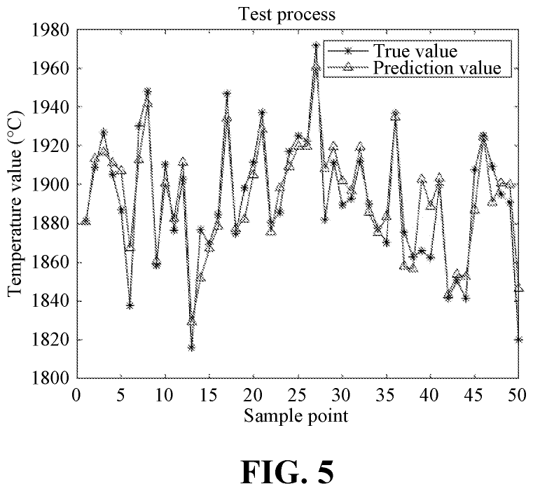

In the embodiment, Matlab is further utilized for simulation experiment, wherein the iterative curve of the sine cosine optimization algorithm is as shown in FIG. 3; and it can be seen from the iterative curve that the curve is convergent, which shows that the optimal parameter has been found in the process of 40 iterations through the sine cosine optimization algorithm. After determination of the parameters, the model provided by the present invention is used for modeling; in order to facilitate observation, the follow effect diagram of the model provided by the present invention as shown in FIG. 4 on the first 50 samples of the training data and the follow effect diagram on the first 50 samples of the test data as shown in FIG. 5 are drawn in the embodiment. It should be further noted that root mean square errors of the training process and the test process are calculated on the training set consisting of 1000 samples and the test set consisting of 200 samples separately. From the view of a follow curve, either in the training process or in the test process, the predicted values of the model provided by the present invention can properly follow the true value, and reach satisfactory results; and the specific values of the root mean square errors RMSE of the training process and the test process are as shown in Table 1.

TABLE 1
Evaluation index of experimental process

| Evaluation | Training | Test |
|---|---|---|
| index | process | process |
| RMSE | 0.0067 | 14.4661 |

Finally, it should be noted that the embodiments are merely intended to describe the technical schemes of the invention, rather than to limit the invention. Although the invention is described in detail with reference to the above embodiments, persons of ordinary skilled in the art should understand that they may still make modifications to the technical schemes described in the above embodiments or make equivalent replacements to some or all technical features thereof. However, these modifications or replacements do not cause the essence of the corresponding technical schemes to depart from the scope of the technical schemes of the embodiments of the invention.

What is claimed is:

1. A modeling method for soft measurement of temperature of a blast furnace tuyere raceway, comprising the following steps:
step 1: collecting picture data of flame combustion at the blast furnace tuyere raceway, physical variable data reflecting operation states of a blast furnace and combustion temperature data of the blast furnace tuyere raceway;
step 2: extracting characteristics of the picture data of the flame combustion at the blast furnace tuyere raceway;
step 3: constructing a multi-kernel least squares support vector regression model based on a Pearson correlation coefficient method and a least squares support vector regression algorithm as a soft measurement model for the temperature of the blast furnace tuyere raceway;
step 4: optimizing parameters of the soft measurement model for the temperature of the blast furnace tuyere raceway by using a sine cosine optimization algorithm; and
step 5: taking optimal kernel function parameters of the picture data, kernel function parameters of the physical variable data and regularization parameters in the multi-kernel least squares support vector regression model, found in step 4, as final parameters of the soft measurement model for the temperature of the blast furnace tuyere raceway, and achieving prediction and calculation of the combustion temperature of the blast furnace tuyere raceway.

2. The modeling method according to claim 1, wherein step 1 comprises:
step 1.1: collecting the picture data of flame combustion at the blast furnace tuyere raceway;
step 1.2: collecting the physical variable data reflecting the operation states of the blast furnace, wherein
the physical variable data reflecting the operation states of the blast furnace includes hot air temperature, hot air pressure, cold air flow, furnace top pressure, pure oxygen flow and gas utilization rate; and
step 1.3: collecting the combustion temperature data of the blast furnace tuyere raceway.

3. The modeling method according to claim 2, wherein step 2 comprises:
step 2.1: converting the picture data of flame combustion at the blast furnace tuyere raceway, collected in step 1.1, into an HSV color space from an RGB color space; and
step 2.2: extracting HSV nonuniform quantization characteristics of the picture data of flame combustion at the blast furnace tuyere raceway from the HSV color space.

4. The modeling method according to claim 3, wherein step 3 comprises:
step 3.1: using the picture data of flame combustion at the blast furnace tuyere raceway and the physical variable data reflecting the operation states of the blast furnace, obtained in step 1.1 and step 1.2, as sample input data, and using the combustion temperature data of the blast furnace tuyere raceway, obtained in step 1.3, as sample temperature label data;
step 3.2: determining kernel function types and the kernel function parameters corresponding to the picture data collected in step 1.1 and the physical variable data collected in step 1.2, and calculating kernel matrices corresponding to the picture data and the physical variable data, respectively;
step 3.3: multiplying the combustion temperature data and a transpose vector thereof to construct a tuyere raceway combustion temperature data matrix on the premise of limiting the combustion temperature data of the blast furnace tuyere raceway obtained in step 1.3 as a column vector;
step 3.4: expanding by columns the kernel matrices calculated according to the picture data and the physical variable data in step 3.2 and the tuyere raceway combustion temperature data matrix constructed in step 3.3, and converting the kernel matrices into corresponding column vectors;
step 3.5: calculating a correlation coefficient between the column vectors corresponding to the picture data and the column vectors corresponding to the tuyere raceway combustion temperature data matrix by using the Pearson correlation coefficient method;
and calculating a correlation coefficient between the column vectors corresponding to the physical variable data and the column vectors corresponding to the tuyere raceway combustion temperature data matrix by using the Pearson correlation coefficient method;
step 3.6: determining weights of the kernel matrices of the picture data and the physical variable data, and constructing a combined kernel matrix of the blast furnace tuyere raceway by using a weighted summation method; and
step 3.7: constructing the multi-kernel least squares support vector regression model based on the least squares support vector regression algorithm by using the combined kernel matrix constructed in step 3.6 and the temperature label data in step 3.1 as the soft measurement model for the temperature of the blast furnace tuyere raceway.

5. The modeling method according to claim 4, wherein step 3.6 comprises:
after the correlation coefficients between the column vectors corresponding to the picture data and the column vectors corresponding to the tuyere raceway combustion temperature data matrix and between the column vectors corresponding to the physical variable data and the column vectors corresponding to the tuyere raceway combustion temperature data matrix are calculated in step 3.5 by using the Pearson correlation coefficient method, respectively, taking a respective proportion of the correlation coefficients corresponding to the picture data and the physical variable data to a sum of the correlation coefficients as a weight of each kernel matrix; and multiplying the kernel matrices of the picture data and the physical variable data by respective weights, and then performing a summation to form the combined kernel matrix.

6. The modeling method according to claim 4, wherein step 4 comprises:
step 4.1: determining parameter optimization objects, wherein the parameter optimization objects are the kernel function parameters of the picture data and the kernel function parameters of the physical variable data in step 3.2, and the regularization parameters in the multi-kernel least squares support vector regression model; and
step 4.2: taking a root mean square error index of the soft measurement model for the temperature of the blast furnace tuyere raceway in step 3 as a fitness function of the sine cosine optimization algorithm, calculating all processes in step 3 in a cyclic iteration before optimal parameters are obtained, and ending the parameter optimization process after iterative termination conditions set by the sine cosine optimization algorithm are met.
